(19) United States
(12) Patent Application Publication
(10) Pub. No.: US 2018/0089719 A1
(43) Pub. Date: Mar. 29, 2018

(54) SYSTEM FOR ENHANCING FOOD AND BEVERAGE SHOPPING

(71) Applicant: Audie Rex Turner, III, Albany, GA (US)

(72) Inventor: Audie Rex Turner, III, Albany, GA (US)

(21) Appl. No.: 15/275,950

(22) Filed: Sep. 26, 2016

(51) Int. Cl. G06Q 30/02; H04W 4/20; G06Q 50/12

(52) U.S. Cl. CPC G06Q 30/0269; G06Q 50/12; H04W 4/206

(57) ABSTRACT

A system for facilitating the shopping process is provided. The system embodies a computer implemented method of scanning content labels of containers of food and beverages contents, selectively retrieving content information pertaining to the food and beverages contents. An image of the food and beverages contents may appear on a user interface of the computer, as well as exploitable information such as recipes and promotional information such as rebates and coupons. A third party user of the contents may be notified through the software application each time the content label is scanned by the computer. The system may be coupled to social networks and other online platform utilized by the user so that portions of the content information may be represented thereon.

### BACKGROUND OF THE INVENTION

The present invention relates to shopping and, more particularly, to a system for facilitating the shopping experience by providing a software application adapted to empower personal computers to scan readable content labels on containers of such contents, thereby retrieving from the content label associated content information pertaining, wherein primary users can exploit the content information and third-party users may exploit the primary user's use.

When shopping for food and beverages, shoppers are always looking for information related to the choices they have to make in the shopping marketplace. For example, such information includes how to get the best price for the food or beverage, information regarding how to prepare the food or beverages for personal consumption or for entertaining purposes, and the like. Similarly, suppliers of the food and beverages are looking to obtain information about those people who buy or are considering buying their food and beverage products. So shoppers are spending time researching through search engines for such information, while the suppliers are waiting on and relying on information from the sellers about who purchased what goods.

As can be seen, there is a need for a system for facilitating the shopping experience through a software application and labeling system adapted to provide related information to the shoppers of food and beverage products and related information to the suppliers who supply them.

### SUMMARY OF THE INVENTION

In one aspect of the present invention, a system for facilitating the shopping experience includes a software application requiring personal information of a user to be operable, wherein the software application is loaded on a computer having a user interface; a container of contents; a readable content label providing retrievable content information, wherein the content information includes exploitable and promotional information provided by a third party database, and wherein the content information pertains to the contents of the container; and a computer-implemented scanner provided the software application loaded thereon, wherein the scanner is adapted to scan the readable content label and the software application exports the personal information to the third party database.

In another aspect of the present invention, the system for facilitating the shopping experience a software application requiring personal information of a user to be operable, wherein the software application is loaded on a computer having a user interface; a container of food or beverages; a readable content label providing retrievable content information, wherein the content information includes exploitable and promotional information provided by a third party database, and wherein the content information pertains to the contents of the container; a computer-implemented scanner provided the software application loaded thereon, wherein the scanner is adapted to scan the readable content label and the software application exports the personal information to the third party database; a search box on the user interface for searching for predetermined contents; and an online platform coupled to the software application, wherein the online platform is configured to electronically represent the content information and personal information, wherein the promotional information includes rebates or coupons, and wherein the exploitable information includes recipes utilizing the food or beverages.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, illustrating the present invention in use;

FIG. 2 is a schematic view of an exemplary embodiment of the present invention;

FIG. 3 is a schematic view of an exemplary embodiment of the present invention;

FIG. 4 is a schematic view of an exemplary embodiment of the present invention;

FIG. 5 is a flow chart of an exemplary embodiment of the present invention; and

FIG. 6 is a continuation of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a software application adapted to scan containers of food and beverages contents, wherein the container has a barcode providing retrievable content information pertaining to the food and beverages contents. The software application may be downloaded on a user's personal computer, such as a smart device and the like. As a result, the user need not spend time googling, researching through search engines, in order to access information pertaining to the contents. An image of the food and beverages contents may appear on the user interface, as well as exploitable information such as recipes and promotional information, including but not limited to rebates and coupons. The supplier of the contents may be notified through the software application each time the barcode is scanned by a software application enabled computer or at the register. The software application may be coupled to social networks and other online platform utilized by the user so that portions of the content information may be represented thereon.

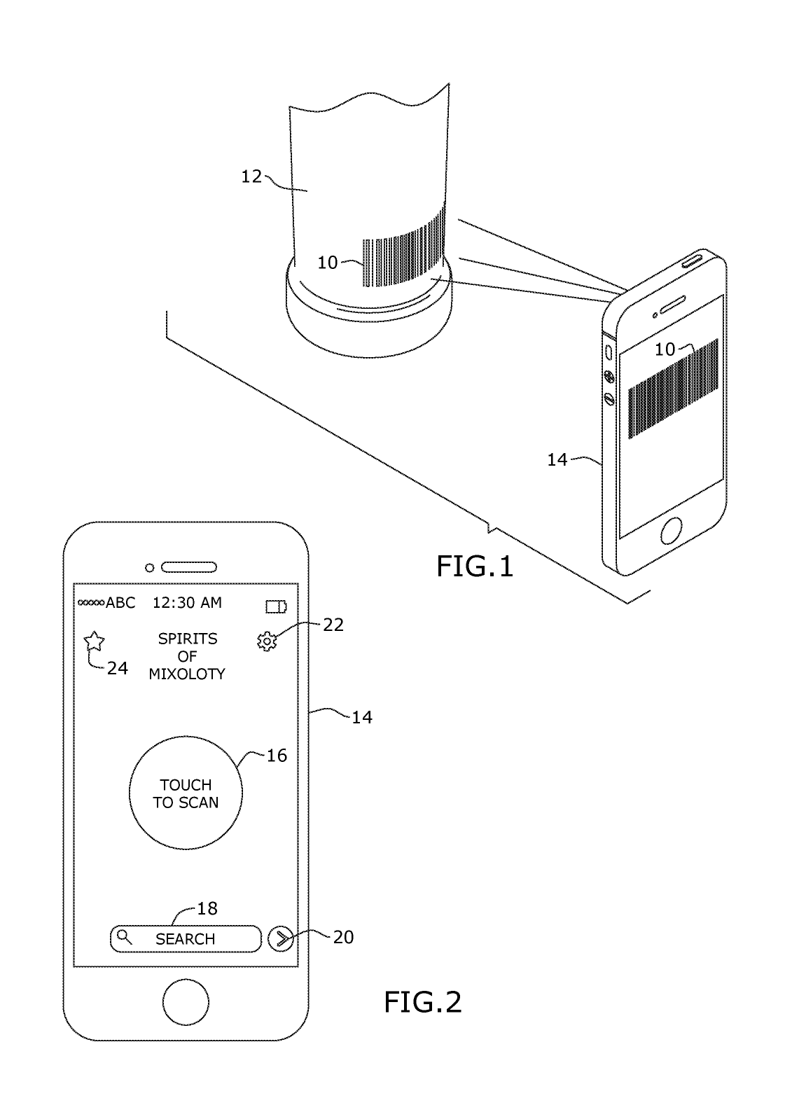

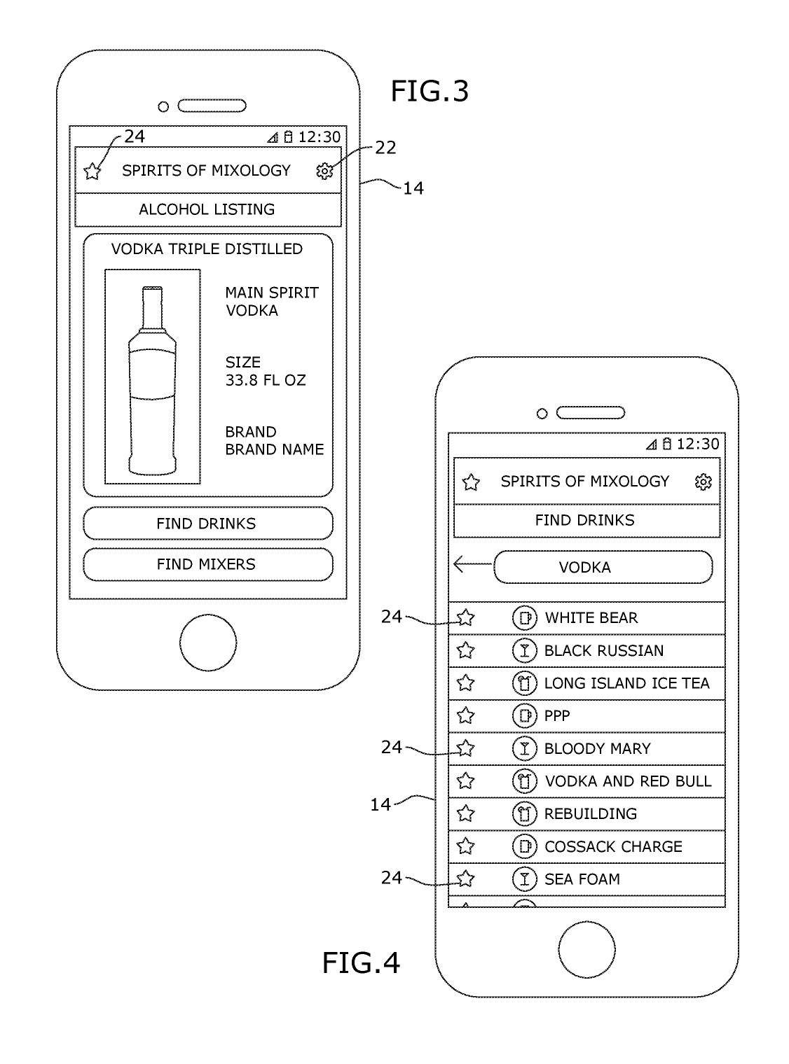

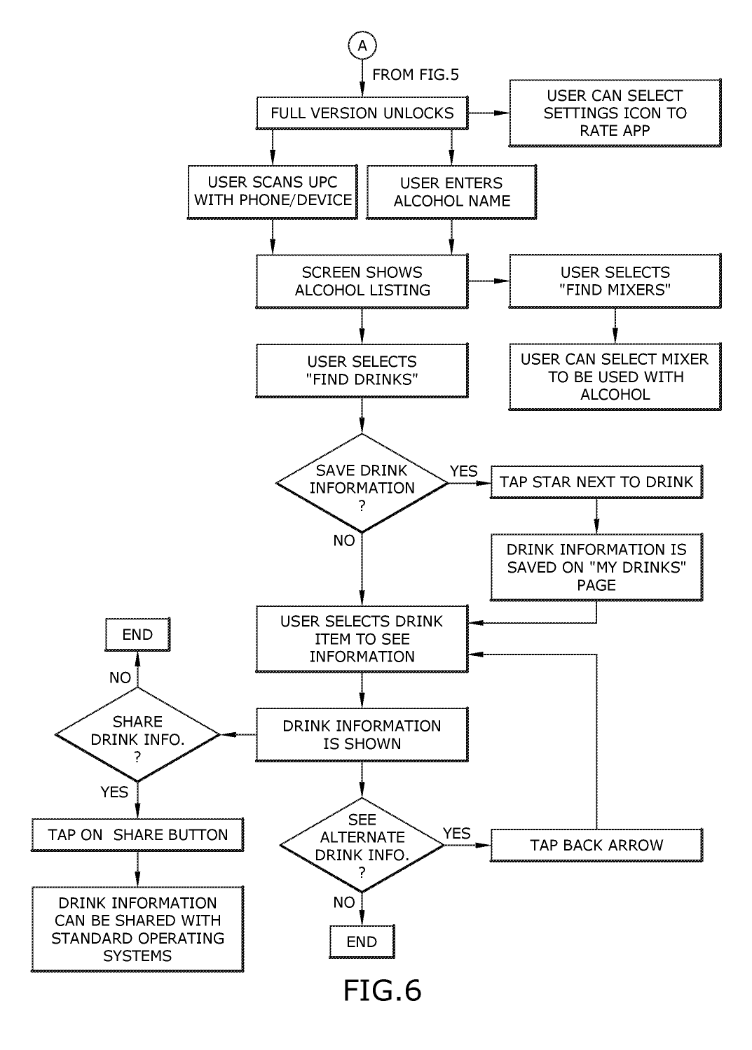

Referring to FIGS. 1 through 6, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a shopping information system embodying at least one electronically-readable content label 10 and the above mentioned software. Each content label 10 may provide machine-readable code, such as QR code or the like. The electronically-readable content label 10/machine-readable code may be associated with inputted content information stored on a database accessible by a third party, such as a supplier of the contents. The database may include but not be limited to the cloud or other forms of memory accessible by the computer. The software may be adapted to read the electronically-readable content label 10, and retrieve, store and export the associated inputted content information.

Each content label 12 includes a unique and verifiable alpha numeric code embodied in the machine readable code. Each content label 12 may include significant adhesive for adhering to the container 12.

The software is enabled to scan the machine-readable code so that personal information about the primary user may be stored in the database for further filtering, compiling, and organizing, and then for retrieval from said database by the third part users. Such inputted content information relates to the associated contents, that is then linked to and thus retrievable by way of the respective unique and verifiable alpha numeric code. The content information may include, but is not limited to, promotional information and exploitable information.

The method of using the present invention includes the following. The shopping information system disclosed above may be provided. At least one content label 10 may be applied to each predetermined container 12 of associated contents. In certain embodiments, the software provides a scan button 16 (or an electronic representation of a scan button on the user interface of the computer), which when triggered, prompts the software to read the machine-readable code of each content label 10. Such content information may include exploitable information, promotional information and the like. The exploitable information may include data relating to and recipes for using the contents and the container 12 it is stored in. The promotional information may include rebates and the like. Such content information may be retrievably stored on the database by the third party user. Such content information may be visually represented on the user interface of the computer, as illustrated in FIGS. 2 through 4. The software application may provide through the user interface a search box 18, a search arrow 20, a setting button 22, and a star button 24 functionality to facilitate the organization and retrieval of the content information.

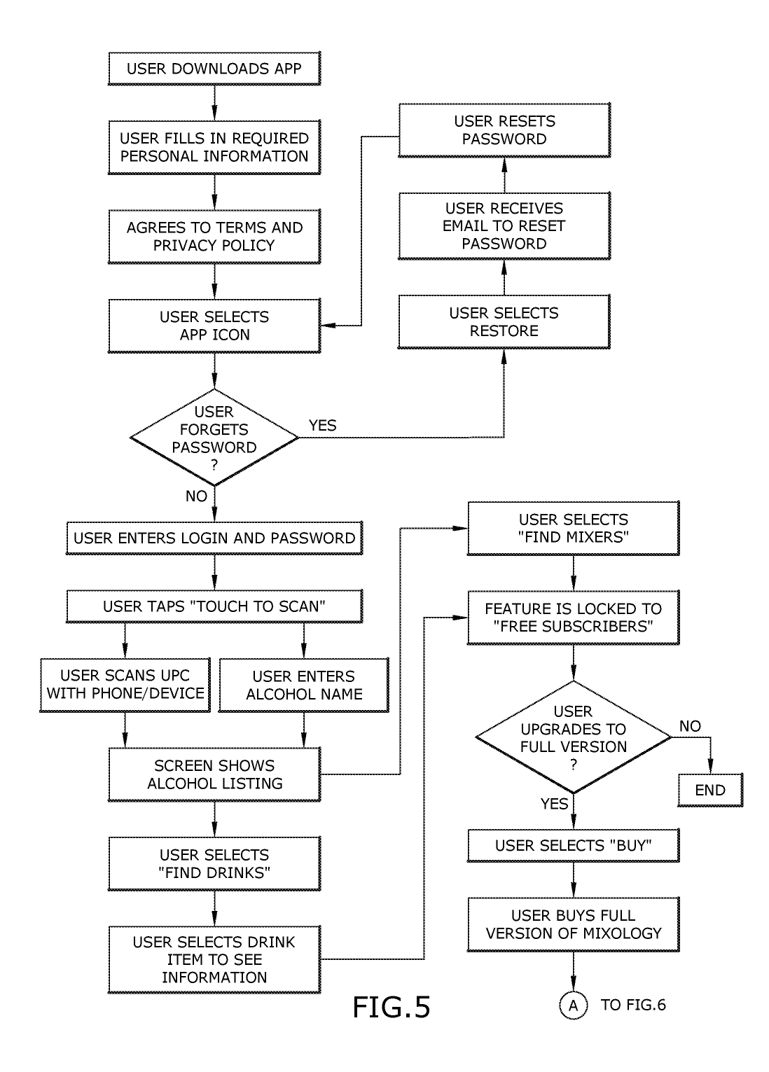

The method of using the present invention may include an initial step of a primary user downloading the software application, filling in the required personal information, agreeing to associated terms of privacy policies, selection of user icon, selection or utilization of a password or retrieval of a lost password, as illustrated in FIG. 5.

The primary user may enter login and password information, tap the “touch to scan” button 16, then scan the content label 10, or searches for a specific content through the search box 18, whereby the user interface represents the contents associated with the content label 10 and/or the search box inquiry, so that the primary user may select to access the content information associated with the scanned content label 10.

The present invention may be locked to free subscribers, whereby a plurality of upgrades is available for purchase, wherein the full upgrade version enables primary users to rate the system.

The primary user may selectively scan a plurality of content labels 10 and/or enter predetermined contents in the search box 18, which represent the associated contents and the associated content information for the user to selectively search, store and/or export. The content information may include a recipe screen, a mixer screen, a picture of the recipe and an ingredients screen.

Exportation of the content information and a portion of the required personal information may be to an online social network platform, wherein the software application provides a “my drinks page,” or to other users of the present invention by tapping on a share button (not shown). The “my drinks page” enables users to build a profile through the required personal information that links up with the social network platforms to chat and post party pictures and instant rebates products.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented system comprising:
a software application requiring personal information of a user to be operable, wherein the software application is loaded on a computer having a user interface;
a container of contents;
a readable content label providing retrievable content information, wherein the content information includes exploitable and promotional information provided by a third party database, and wherein the content information pertains to the contents of the container; and
a computer-implemented scanner provided the software application loaded thereon, wherein the scanner is adapted to scan the readable content label and the software application exports the personal information to the third party database.

2. The system of claim 1, wherein the promotional information includes rebates or coupons.

3. The system of claim 1, wherein the contents are food or beverages.

4. The system of claim 3, wherein the exploitable information includes recipes utilizing the food or beverages.

5. The system of claim 1, further comprising an online platform coupled to the software application, wherein the online platform is configured to electronically represent the content information and personal information.

6. The system of claim 1, further comprising a search box on the user interface for searching for predetermined contents.

7. A computer implemented system comprising:
a software application requiring personal information of a user to be operable, wherein the software application is loaded on a computer having a user interface;
a container of food or beverages;
a readable content label providing retrievable content information, wherein the content information includes exploitable and promotional information provided by a third party database, and wherein the content information pertains to the contents of the container;
a computer-implemented scanner provided the software application loaded thereon, wherein the scanner is adapted to scan the readable content label and the software application exports the personal information to the third party database;
a search box on the user interface for searching for predetermined contents; and
an online platform coupled to the software application, wherein the online platform is configured to electronically represent the content information and personal information,
wherein the promotional information includes rebates or coupons, and wherein the exploitable information includes recipes utilizing the food or beverages.
